(19) United States
(12) Patent Application Publication
(10) Pub. No.: US 2026/0042336 A1
(43) Pub. Date: Feb. 12, 2026

(54) HEAT MANAGEMENT SYSTEM

(71) Applicant: AISAN KOGYO KABUSHIKI KAISHA, Obu-shi, Aichi (JP)

(72) Inventors: Makoto NAKAGAWA, Nagoya-shi (JP); Tomonori NAGASE, Chita-gun (JP); Yoichi NAKAO, Toyokawa-shi (JP)

(73) Assignee: AISAN KOGYO KABUSHIKI KAISHA, Obu-shi, Aichi (JP)

(21) Appl. No.: 19/150,068

(22) PCT Filed: Nov. 27, 2023
(86) PCT No.: PCT/JP2023/042300

§ 371 Date: Jul. 22, 2025

(30) Foreign Application Priority Data
Feb. 16, 2023 (JP) 2023-022067

(51) Int. Cl. B60H 1/22; B60H 1/00; H01M 10/625

(52) U.S. Cl. CPC B60H 1/2218; B60H 1/00485; B60H 1/00899; H01M 10/625; B60H 2001/00949; B60H 2001/2271

(57) ABSTRACT

This heat management system includes a heat pump circuit which includes: a first circulation path through which a refrigerant circulates; a compressor provided in the first circulation path to compress the refrigerant; an expansion valve provided in the first circulation path to expand the refrigerant; a first condenser provided between the compressor and the expansion valve in the first circulation path to release heat into room air; and a first evaporator which is placed in the first circulation path between the compressor and the expansion valve and at a position on the side opposite to the position of the first condenser, and which absorbs heat from atmospheric air. A first bypass path which bypasses the first evaporator is provided for the first circulation path, and the first bypass path is provided with a first heater which heats the refrigerant flowing through the first bypass path.

### TECHNICAL FIELD

The technique disclosed in this description relates to a heat management system, which is mounted in, for example, an electric vehicle to manage transfer of heat to a vehicle interior, a battery, etc.

### BACKGROUND ART

A conventional example of the above-mentioned techniques is known as an “air conditioning device for a vehicle” described in Patent Document listed below. This device is mounted in an electric vehicle and provided with a heat pump, a battery circuit that exchanges heat with the heat pump, a cooling heat exchange circuit that exchanges heat with the heat pump and the vehicle interior during cooling, and a heating heat exchange circuit that exchanges heat with the heat pump during heating. The heating heat exchange circuit is provided with a heater to heat a heating medium that flows through this circuit.

### RELATED ART DOCUMENTS

### Patent Documents

Patent Document 1: Japanese unexamined patent application publication No. 2015-182487 (JP 2015-182487 A)

### SUMMARY OF INVENTION

### Problems to be Solved by the Invention

However, the device described in Patent Document 1 includes the heater in the heating heat exchange circuit in order to perform heat exchange with the heat pump during heating, and thus the heater needs to be warmed up to a high temperature. This heater is therefore required to have a high heat resistance, which increases in cost. Since a temperature difference is not generated between the heating medium and the heater, the heater is further required to have a wider area for heat exchange and thus tends to increase in size and weight. The entire device is consequently increased in size and weight.

The present disclosure has been made to address the above problems and has a purpose to provide a heat management system that can operate a heat pump by using a low-cost, compact, and lightweight heater, to reduce the size, weight, and cost.

### Means of Solving the Problems

(1) To achieve the above purpose, one aspect of the disclosure provides a heat management system provided with a heat pump, the heat pump comprising: a first circulation path through which a medium circulates; a compressor provided in the first circulation path to compress the medium; an expansion valve provided in the first circulation path to expand the medium; a first condenser placed in the first circulation path between the compressor and the expansion valve to release heat into air in a room interior; and a first evaporator placed between the compressor and the expansion valve, in a position opposite to a position of the first condenser to absorb heat from atmosphere, wherein the system comprises: a first bypass path provided for the first circulation path and extended bypassing the first evaporator; and a first heater placed in the first bypass path to heat the medium that flows through the first bypass path.

According to the above-described configuration (1), the heat pump is configured such that the first condenser that releases heat into the room interior air is placed in the first circulation path through which a medium circulates, on one side between the compressor and the expansion valve, and the first evaporator that absorbs heat from the atmosphere is placed between the compressor and the expansion valve, on the opposite side to the position of the first condenser. Here, the heat pump can be activated when a medium is heated to a predetermined temperature (e.g., 0°). In the above configuration, the first heater is placed in the first bypass path that detours around the first evaporator in the first circulation path to heat the medium flowing through the first bypass path. Since the first heater is located on the side close to the first evaporator that absorbs heat from the atmosphere, under extremely-low atmosphere temperatures, the heat pump can be activated simply by heating the medium passing through the first heater to nearly 0° and this heated medium is circulated to the first condenser via the first bypass path and the first circulation path. Specifically, the room interior can be heated by the heat released from the first condenser to the room interior air. Accordingly, the first heater does not need to have a high heat resistance and a wider area.

(2) To achieve the above purpose, the above-described configuration (1) preferably comprises: a second bypass path provided for the first circulation path and extended bypassing the first condenser; a second condenser placed in the second bypass path; a second circulation path through which another medium circulates, provided in the second condenser; and a battery that is placed in the second circulation path and heated by the other medium, the second condenser being configured to exchange heat between the medium in the second bypass path and the other medium in the second circulation path.

According to the above-described configuration (2), in addition to the operations of the foregoing configuration (1), the second condenser performs heat exchange between the medium in the second bypass path and the other medium in the second circulation path, so that the heat of the other medium warms up the battery.

(3) To achieve the above purpose, the above-described configuration (1) or (2) preferably comprises a first switching valve for switching a flow of the medium between the first circulation path and the first bypass path.

According to the above-described configuration (3), in addition to the operations of the foregoing configuration (1) or (2), the first switching valve switches the flow of the medium in the first circulation path so that the medium selectively flows to the first bypass path.

(4) To achieve the above purpose, the above-described configuration (1) or (2) preferably comprises a second switching valve for switching a flowing direction of the medium in the compressor.

According to the above-described configuration (4), in addition to the operations of the foregoing configuration (1) or (2), in the heat pump, the second switching valve switches the flowing direction of the medium in the first circulation path between a forward direction and a reverse direction, changing over the flowing direction of the medium in the compressor and further the flowing direction of the medium in the expansion valve. The operations of the compressor and the expansion valve switch from the function of releasing heat from the first condenser into the air (the heating function) to the opposing, cooling function.

(5) To achieve the above purpose, the above-described configuration (3) preferably further comprises a control unit for controlling the first switching valve and the first heater, wherein when the medium is below a predetermined temperature, the control unit controls the first switching valve to switch the flow of the medium in the first circulation path to the first bypass path and controls the first heater to be operated.

According to the above-described configuration (5), in addition to the operations of the foregoing configuration (3), when the medium is below the predetermined temperature, the control unit controls the first switching valve to switch the flow of the medium in the first circulation path to the first bypass path and activates the first heater.

(6) To achieve the above purpose, in the above-described configuration (5), preferably, the control unit controls the first switching valve to gradually change the flow of the medium between the first circulation path and the first bypass path.

According to the above-described configuration (6), in addition to the operations of the foregoing configuration (5), the control unit controls the first switching valve to gradually change the flow of the medium between the first circulation path and the first bypass path. Thus, the flow rate of the medium that flows into the first heater gradually changes.

### Effects of the Invention

According to the above-described configuration (1), it is possible to operate the heat pump using a low-cost, compact, and lightweight heater, and hence reduce the size, weight, and cost of the heat management system.

According to the above-described configuration (2), in addition to the effects of the foregoing configuration (1), it is possible to effectively warm up the battery in addition to heating of the vehicle interior.

According to the above-described configuration (3), in addition to the effects of the foregoing configuration (1) or (2), it is possible to direct the flow of the medium in the first circulation path to the first heater as needed.

According to the above-described configuration (4), in addition to the operations of the foregoing configuration (1) or (2), this heat management system can perform both the heating function and the cooling function.

According to the above-described configuration (5), in addition to the effects of the foregoing configuration (3), it is possible to selectively operate the first heater according to the temperature of the medium, and achieve energy savings in the use of the first heater.

According to the above-described configuration (6), in addition to the effects of the foregoing configuration (5), it is possible to suppress abrupt temperature change of the medium heated by the first heater.

### BRIEF DESCRIPTION OF THE DRAWINGS

FIG. 1 is a block diagram schematically showing a heat management system in a first embodiment, which will be mounted in an electric vehicle.

FIG. 2 is a flowchart showing contents of a control program in the first embodiment.

FIG. 3 is a time chart showing behaviors of various parameters under control in the first embodiment.

FIG. 4 is a block diagram schematically showing a heat management system in a second embodiment, which will be mounted in an electric vehicle.

FIG. 5 is a block diagram schematically showing a heat management system in a third embodiment, which will be mounted in an electric vehicle.

FIG. 6 is a block diagram schematically showing a heat management system in a fourth embodiment, which will be mounted in an electric vehicle.

FIG. 7 is a block diagram schematically showing a heat management system in a fifth embodiment, which will be mounted in an electric vehicle.

FIG. 8 is a block diagram schematically showing a heat management system in a sixth embodiment, which will be mounted in an electric vehicle.

### MODE FOR CARRYING OUT THE INVENTION

A detailed description of several embodiments of a heat management system, which is embodied in a cooling and heating device of an electric vehicle, will now be given referring to the accompanying drawings.

### First Embodiment

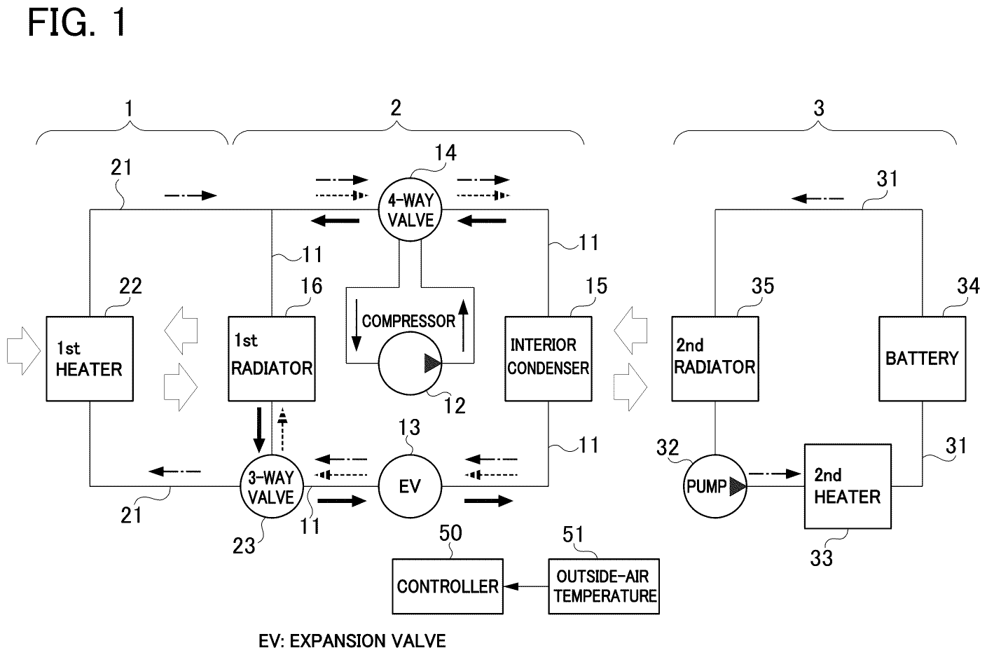

A first embodiment will be described in detail with reference to FIGS. 1 to 3.

### (Configuration of Heat Management System)

FIG. 1 is a block diagram schematically showing a heat management system in this embodiment, which is mounted in an electric vehicle. As shown in FIG. 1, this system is constituted of a heater circuit 1, a heat pump circuit 2, and a powertrain cooling circuit 3. In FIG. 1, thick arrows indicate the flow of a medium during cooling, dot-dashed arrows indicate the flow of a medium during heating when the atmosphere (outside air) is less than 0° C., dashed arrows indicate the flow of a medium during heating when the outside air is 0° C. or higher, and solid arrows indicate the flow of a medium between a compressor 12 and a 4-way valve 14. In this embodiment, a predetermined refrigerant is used in the heater circuit 1 and the heat pump circuit 2 as one example of a “medium” of this disclosure, and a coolant, or cooling water, is used in the powertrain cooling circuit 3 as one example of “another medium” of the disclosure.

### (Heat Pump Circuit)

The heat pump circuit 2 in the present embodiment includes a first circulation path 11 through which a medium circulates. In the first circulation path 11, the compressor 12, which is electrically driven, is placed to compress a refrigerant, and an expansion valve 13, which is electrically driven, is placed to expand a refrigerant. The compressor 12 is provided in the first circulation path 11 via the 4-way valve 14, which is electrically driven. The 4-way valve 14 is provided to switch the flowing direction of the refrigerant in the compressor 12, and corresponds to one example of a “second switching valve” of this disclosure.

In the first circulation path 11, an interior condenser 15 for releasing heat into the air in a vehicle interior is placed between the compressor 12 and the expansion valve 13. The interior condenser 15 corresponds to one example of a “first condenser” of this disclosure. Further, in the first circulation path 11, a first radiator 16 for absorbing heat from the atmosphere (outside air) is placed between the compressor 12 and the expansion valve 13, in an opposite position to the position of the interior condenser 15. The first radiator 16 corresponds to one example of a “first evaporator” of this disclosure.

### (Heater Circuit)

In the present embodiment, the heater circuit 1 is placed on the atmosphere side of the heat pump circuit 2. This heater circuit 1 includes a first bypass path 21 that bypasses the first radiator 16 in the first circulation path 11. In the first bypass path 21, a first heater 22, which is electrically operated, is placed to heat the refrigerant flowing through the first bypass path 21.

In the present embodiment, in order to switch the flow of refrigerant between the first circulation path 11 and the first bypass path 21, a 3-way valve 23, which is electrically driven, is placed at a junction between an upstream part of the first circulation path 11 relative to the first radiator 16 in the flowing direction during heating and the first bypass path 21. This 3-way valve 23, at an opening degree of 0°, connects a part of the first circulation path 11 on the expansion valve 13 side and a part of the first circulation path 11 on the first radiator 16 side. The 3-way valve 23, at an opening degree of 90°, connects the part of the first circulation path 11 on the expansion valve 13 side and a part of the first bypass path 21 on the first heater 22 side. The 3-way valve 23 corresponds to one example of a “first switching valve” of the disclosure.

### (Powertrain Cooling Circuit)

The powertrain cooling circuit 3 in the present embodiment includes a second circulation path 31 through which a coolant circulates. In this path 31, a pump 32, which is electrically driven, is placed most upstream, and a second heater 33, which is electrically operated, a battery 34, and a second radiator 35 are arranged in order. In this powertrain cooling circuit 3, at low temperatures, the coolant discharged from the pump 32 is heated by the second heater 33 up to 0° and then flows to the battery 34, so that the battery 34 is heated by heat exchange with the coolant. After warm-up, the second heater 33 is stopped, and the heat of the coolant discharged from the pump 32 is released to the outside of a vehicle through the second radiator 35, and this coolant then flows to the battery 34, cooling the battery 34. The second radiator 35 absorbs heat from the air inside the vehicle, thereby cooling the vehicle interior.

### (Electrical Configuration)

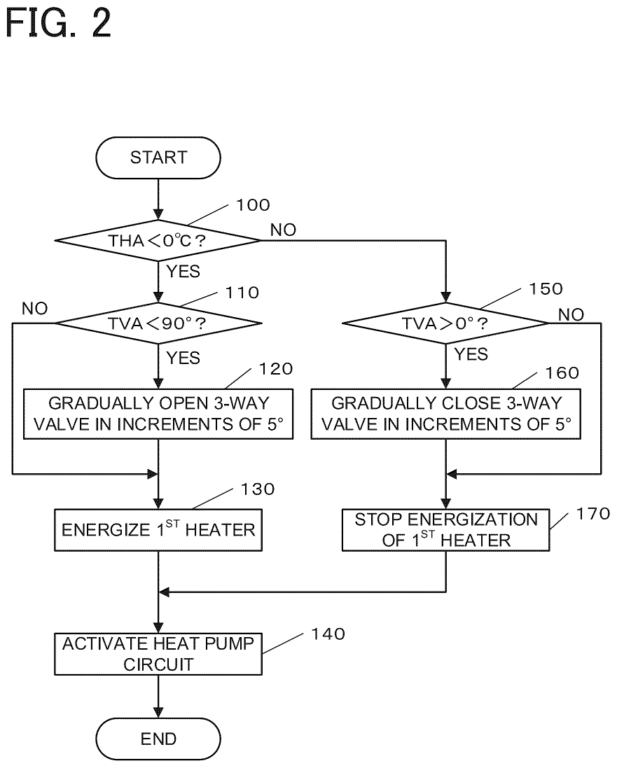

Next, the electrical configuration will be described. As shown in FIG. 1, this system further includes a controller 50 used for control and an outside-air temperature sensor 51 for detecting the temperature of outside air (outside air temperature) THA. The controller 50 is configured to control the 3-way valve 23, 4-way valve 14, compressor 12, expansion valve 13, first heater 22, pump 32, and second heater 33 based on detection results of the outside air temperature THA. The controller 50 corresponds to one example of a “control unit” of this disclosure. The controller 50 is configured to execute a predetermined control program. FIG. 2 shows, in a flowchart, the contents of the control program.

When the processing enters this routine, the controller 50 determines, in step 100, whether or not the outside air temperature THA is “less than 0° C.”. The controller 50 advances the processing to step 110 when the determination result is affirmative, but shifts the processing to step 150 when the determination result is negative.

In step 110, the controller 50 determines whether or not the opening degree TVA of the 3-way valve 23 is “less than 90°”. The controller 50 can determine this opening degree TVA from a command value to the 3-way valve 23. The controller 50 advances the processing to step 120 when the determination result is affirmative, but causes the processing to skip to step 130 when the determination result is negative.

In step 120, the controller 50 causes the 3-way valve 23 to gradually open in increments of 5°. Specifically, when the outside air temperature THA is less than 0° C., the controller 50 switches the 3-way valve 23 by gradually opening the 3-way valve 23 so that the refrigerant temperature does not change abruptly.

In step 130, the controller 50 energizes the first heater 22, thereby heating the refrigerant.

In step 140, consequently, the controller 50 drives the heat pump circuit 2. For this purpose, the controller 50 operates the compressor 12. Then, the controller 50 temporarily halts the processing.

Specifically, when the outside air temperature THA is less than 0° C., the controller 50 flows the refrigerant to the first heater 22 and energizes the first heater 22 to generate heat, thereby heating the refrigerant. In contrast, when the outside air temperature THA is 0° C. or higher, the controller 50 flows the refrigerant to the first radiator 16 so the refrigerant absorbs the heat of outside air.

On the other hand, in step 150 following step 100, the controller 50 determines whether or not the opening degree TVA of the 3-way valve 23 is larger than 0°. The controller 50 advances the processing to step 160 when the determination result is affirmative, but causes the processing to skip to step 170 when the determination result is negative.

In step 160, the controller 50 gradually closes the 3-way valve 23 in increments of 5°. Specifically, when the outside air temperature THA is 0° C. or higher, the controller 50 switches the 3-way valve 23 by gradually closing the 3-way valve 23 so that the refrigerant temperature does not abruptly change.

In step 170, the controller 50 stops energizing the first heater 22, thereby stopping heating the refrigerant. Then, the controller 50 shifts the processing to step 140.

According to the above-described control program, when the refrigerant is less than the predetermined temperature (e.g., 0° C.), the controller 50 controls the 3-way valve 23 to switch the flow of refrigerant in the first circulation path 11 to the first bypass path 21 and controls the first heater 22 to operate. Furthermore, the controller 50 controls the 3-way valve 23 so that the flow of the refrigerant between the first circulation path 11 and the first bypass path 21 gradually changes.

When the refrigerant is 0° C. or higher, the 3-way valve 23 allows the refrigerant to flow into the first radiator 16 so that the refrigerant absorbs the heat from the outside air. When the refrigerant is less than 0° C., the first heater 22 is operated to heat the refrigerant.

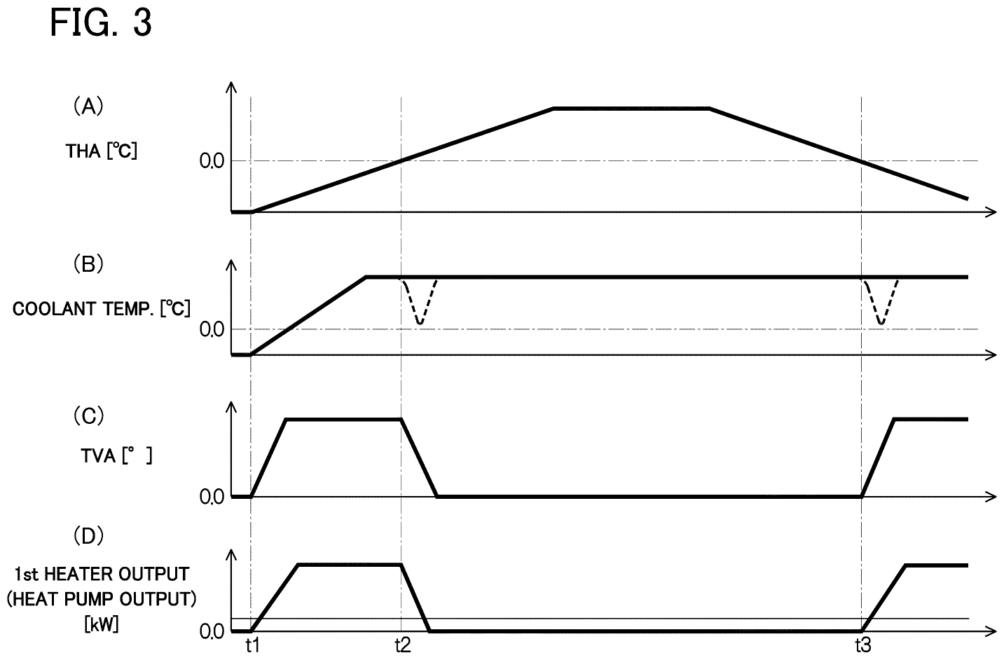

FIG. 3 is a time chart showing the behaviors of various parameters in the foregoing control. In FIG. 3, (A) shows changes in the outside air temperature THA, (B) shows changes in the temperature of refrigerant, (C) shows changes in the opening degree TVA of the 3-way valve, and (D) shows changes in output of the first heater (output of the heat pump).

In FIG. 3, at time t1, (A) the outside air temperature THA and (B) the refrigerant temperature begin to rise from low temperatures on a minus side, (C) the opening degree TVA starts to gradually change from the communication with the first radiator 16 to the communication with the first heater 22, and further (D) the output of the first heater 22 starts to increase.

At time t2, when (A) the outside air temperature THA passes across 0° C. to a plus side, (C) the opening degree TVA of the 3-way valve starts to gradually change from the communication with the first heater 22 to the communication with the first radiator 16, and also (D) the output of the first heater 22 starts to decrease. At that time, (C) the opening degree TVA of the 3-way valve starts to gradually change, and thus (B) the refrigerant temperature does not abruptly change as indicated by a dashed line, but remains at a constant temperature as indicated by a solid line.

At time t3, when (A) the outside air temperature THA passes across 0° C. to a minus side, (C) the opening degree TVA of the 3-way valve starts to gradually change from the communication with the first radiator 16 to the communication with the first heater 22, and also (D) the output of the first heater 22 starts to increase. At that time, (C) the opening degree TVA of the 3-way valve gradually changes, and thus (B) the refrigerant temperature does not abruptly change as indicated by a dashed line, but remains at a constant temperature as indicated by a solid line.

In addition to the above, the controller 50 can control a heating request (temperature, airflow) in a vehicle interior so that the coolant becomes 0° C. or higher by adjusting the outputs of the second heater 33 and the pump 32 according to the outside air temperature THA in order to control the powertrain cooling circuit 3.

### (Operations and Effects of Heat Management System)

According to the configuration of the heat management system in the present embodiment described above, the heat pump circuit 2 is configured such that, in the first circulation path 11 through which the refrigerant (the medium) circulates, the interior condenser 15 (the first condenser) that releases heat into the air inside the vehicle is placed, on one side, between the compressor 12 and the expansion valve 13, and the first radiator 16 (the first evaporator) that absorbs heat from the outside air is placed on the opposite side (the atmosphere side) to the position of the interior condenser 15, between the compressor 12 and the expansion valve 13. Here, the heat pump circuit 2 can be activated when the refrigerant is heated to a predetermined temperature (e.g., 0° C.).

In the configuration in the present embodiment, in the first circulation path 11, the first heater 22 is placed in the first bypass path 21 detouring around the first radiator 16 and heats the refrigerant flowing through this first bypass path 21. The first heater 22 is thus located on the side close to the first radiator 16 that absorbs heat from the atmosphere. Accordingly, under extremely low atmosphere temperatures, when the refrigerant passing through the first heater 22 is heated to nearly 0°, the heat pump circuit 2 can be activated, allowing this heated refrigerant to circulate to the interior condenser 15 via the first bypass path 21 and the first circulation path 11. Specifically, the vehicle interior can be heated by the heat released from the interior condenser 15 into the vehicle interior air. Thus, there is no need to heat the refrigerant to a high temperature (e.g., 60 to 80° C.) as in the conventional case, and hence the first heater 22 does not need to have a high heat resistance and a wider area. For this reason, it is possible to operate the heat pump circuit 2 using the first heater 22 that is low-cost, compact, and lightweight, thereby reducing the size, weight, and cost of the heat management system.

According to the configuration in the present embodiment, the 3-way valve 23 (the first switching valve) can switch the flow of the refrigerant in the first circulation path 11 so that the refrigerant flows selectively to the first bypass path 21. This allows the refrigerant in the first circulation path 11 to flow to the first heater 22 as necessary.

According to the configuration in the present embodiment, in the heat pump circuit 2, the flowing direction of the refrigerant in the first circulation path 11 is switched between the forward direction and the reverse direction by the 4-way valve 14 (the second switching valve), thereby switching the flowing direction of the refrigerant in the compressor 12 and hence the flowing direction of the refrigerant in the expansion valve 13. The operations of the compressor 12 and the expansion valve 13 switch from the function of releasing heat from the interior condenser 15 into the air (the heating function) to the opposing, cooling function. Therefore, this heat management system can perform both the heating function and the cooling function.

According to the configuration in the present embodiment, when the refrigerant is less than the predetermined temperature (e.g., 0° C.), the controller 50 (the control unit) controls the 3-way valve 23 to switch the flow of the refrigerant in the first circulation path 11 to the first bypass path 21, thereby activating the first heater 22. This configuration can therefore selectively operate the first heater 22 according to the temperature of the refrigerant, and achieve energy savings in the use of the first heater 22.

According to the configuration in the present embodiment, the controller 50 controls the 3-way valve 23 to gradually change the flow of the refrigerant between the first circulation path 11 and the first bypass path 21. Thus, the flow rate of the refrigerant that flows to the first heater 22 gradually changes. This can suppress abrupt temperature change of the refrigerant heated in the first heater 22.

### Second Embodiment

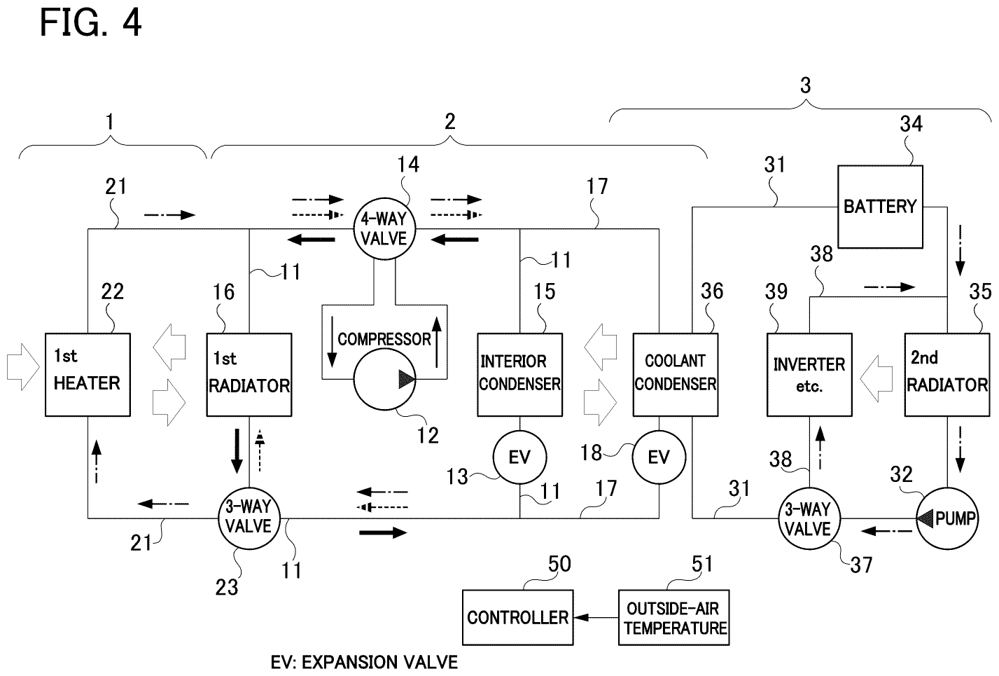

Next, a second embodiment will be described in detail with reference to FIG. 4. In the following description, parts or components equivalent to those in the first embodiment are assigned the same reference signs as those in the first embodiment and their details are not described, and differences from the first embodiment will be focused.

### (Configuration of Heat Management System)

FIG. 4 is a block diagram schematically showing a heat management system in this embodiment, which will be mounted in an electric vehicle. As shown in FIG. 4, the heat management system in this embodiment differs from the first embodiment mainly in the configuration of the powertrain cooling circuit 3.

### (Heat Pump Circuit)

The first circulation path 11 is provided with a second bypass path 17 that bypasses the interior condenser 15, as shown in FIG. 4. In the second bypass path 17, a coolant condenser 36 is placed to exchange heat with the coolant that flows through the second circulation path 31 to heat or cool the battery 34. The coolant condenser 36 corresponds to one example of a “second condenser” of the disclosure. Further, in the second bypass path 17, another expansion valve 18, which is electrically driven, is placed to expand the refrigerant.

### (Powertrain Cooling Circuit)

As shown in FIG. 4, the second circulation path 31 through which a coolant circulates is provided for the coolant condenser 36. The coolant condenser 36 is configured to exchange heat between the refrigerant flowing through the second bypass path 17 and the coolant flowing through the second circulation path 31. This configuration is to warm up the battery 34 with the heat of the heat pump circuit 2. Thus, there is no need to provide an electric heater in the powertrain cooling circuit 3.

As shown in FIG. 4, in the second circulation path 31, in addition to the coolant condenser 36, the battery 34, the second radiator 35, the pump 32, and a 3-way valve 37, which is electrically driven, are placed. The second circulation path 31 is provided with a third bypass path 38 that bypasses the coolant condenser 36 and the battery 34. An upstream end of the third bypass path 38 is connected to the second circulation path 31 via the 3-way valve 37 and a downstream end of the third bypass path 38 is directly connected to the second circulation path 31. In this third bypass path 38, an inverter 39 and others, which are cooled by the coolant, are arranged. Other configurations in FIG. 4 are identical to those in FIG. 1.

### (Operations and Effects of Heat Management System)

According to the configuration of the heat management system in the present embodiment described above, the following operations and effects can be achieved in addition to the operations and the effects in the first embodiment. Specifically, according to the configuration in the present embodiment, the coolant condenser 36 (the second condenser) exchanges heat between the refrigerant in the second bypass path 17 and the coolant in the second circulation path 31, so that the battery 34 is warmed up by the heat of the coolant. This enables effective warming of the battery 34 in addition to vehicle interior heating.

### Third Embodiment

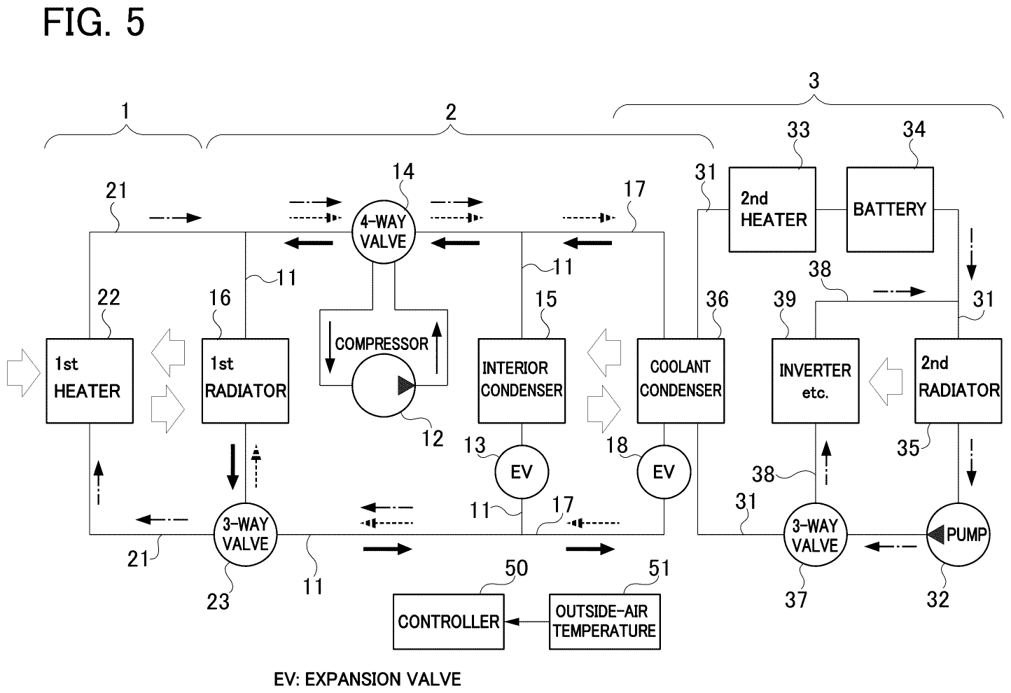

Next, a third embodiment will be described in detail with reference to FIG. 5.

### (Configuration of Heat Management System)

FIG. 5 is a block diagram schematically showing a heat management system in this embodiment, which will be mounted in an electric vehicle. As shown in FIG. 5, the heat management system in this embodiment differs from the second embodiment in the configuration of the powertrain cooling circuit 3.

### (Powertrain Cooling Circuit)

As shown in FIG. 5, in the second circulation path 31, a second heater 33, which is electrically driven, is placed between the coolant condenser 36 and the battery 34. This configuration is to actively heat the coolant with the second heater 33 and actively heat the battery 34 with that heated coolant.

### (Operations and Effects of Heat Management System)

According to the configuration of the heat management system in the present embodiment described above, the following operations and effects can be achieved in addition to the operations and the effects in the second embodiment. Specifically, according to the configuration in the present embodiment, in the second circulation path 31, the second heater 33 is located between the coolant condenser 36 and the battery 34. This configuration can actively heat the coolant by operating the second heater 33, actively heating the battery 34 with that heated coolant.

### Fourth Embodiment

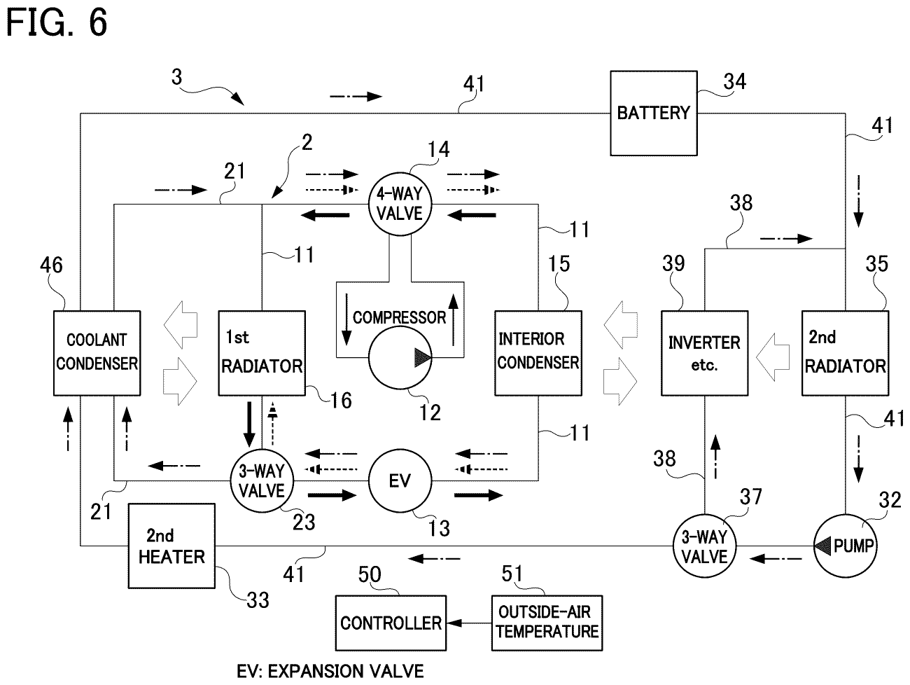

Next, a fourth embodiment will be described in detail with reference to FIG. 6.

### (Configuration of Heat Management System)

FIG. 6 is a block diagram schematically showing a heat management system in this embodiment, which will be mounted in an electric vehicle. As shown in FIG. 6, the configuration of the heat management system in this embodiment differs from the third embodiment as described below.

Specifically, the heat management system in the present embodiment is constituted of the heat pump circuit 2 and the powertrain cooling circuit 3 without the heater circuit 1, and the powertrain cooling circuit 3 performs the function of a heater circuit.

### (Heat Pump Circuit)

As shown in FIG. 6, the heat pump circuit 2 in the present embodiment differs from that in the third embodiment; specifically, the first heater 22 and the second bypass path 17 are omitted, and a coolant condenser 46 is placed, instead of the first heater 22, in the first bypass path 21. This coolant condenser 46 corresponds to one example of a “third condenser” of the disclosure.

### (Powertrain Cooling Circuit)

As shown in FIG. 6, in the powertrain cooling circuit 3 of the present embodiment, a fourth circulation path 41 through which a coolant circulates is provided for the coolant condenser 46. The coolant condenser 46 exchanges heat between the refrigerant flowing through the first bypass path 21 and the coolant flowing through the fourth circulation path 41. This is the configuration for warming up the heat pump circuit 2 with the heat of the powertrain cooling circuit 3. This allows omission of a heater from the heat pump circuit 2.

In the present embodiment, in the fourth circulation path 41, the second heater 33 is placed upstream of the coolant condenser 46, and the battery 34 is placed downstream of the coolant condenser 46.

### (Operations and Effects of Heat Management System)

According to the configuration of the heat management system in the present embodiment described above, the coolant condenser 46 (the third condenser) for releasing heat into the atmosphere is placed in the first bypass path 21 bypassing the first radiator 16 (the first evaporator) in the first circulation path 11. For the coolant condenser 46, the fourth circulation path 41 is provided to exchange heat with the first bypass path 21. In the fourth circulation path 41, furthermore, the second heater 33 is placed upstream of the coolant condenser 46 and the battery 34 is placed downstream of the coolant condenser 46. Accordingly, while the coolant heated by the second heater 33 flows through the fourth circulation path 41, the coolant condenser 46 performs heat exchange between the fourth circulation path 41 and the first bypass path 21. The refrigerant flowing through the first bypass path 21 is thus heated and then flows to the interior condenser 15 via the first circulation path 11. Further, the refrigerant exchanges heat with the coolant flowing through the fourth circulation path 41 from the coolant condenser 46 and the coolant radiates heat in the second radiator 35. In other words, the heat released from the interior condenser 15 into the air enables heating of the vehicle interior. The battery 34 is also warmed up with the heated coolant flowing through the fourth circulation path 41. Since the present embodiment does not have the heater circuit 1 including the first heater 22, unlike the third embodiment, it is possible to reduce the cost of the heat management system just by that much. Further, it is possible to actively heat the refrigerant flowing through the heat pump circuit 2 by utilizing the second heater 33 that constitutes the powertrain cooling circuit 3 for warming up the battery 34 and others.

### Fifth Embodiment

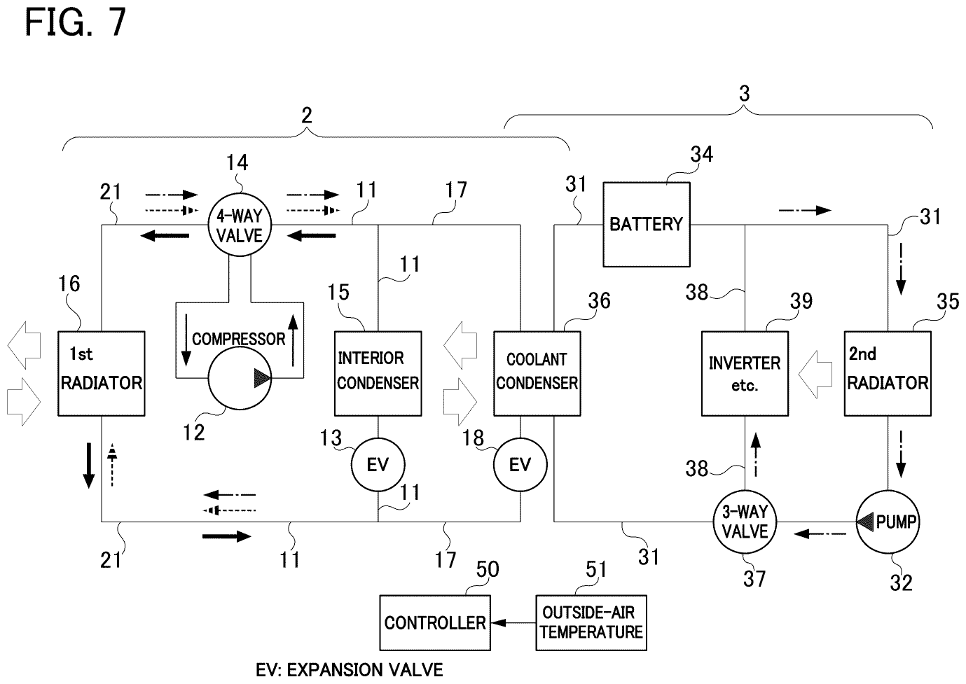

Next, a fifth embodiment will be described in detail with reference to FIG. 7.

### (Configuration of Heat Management System)

FIG. 7 is a block diagram schematically showing a heat management system in this embodiment, which will be mounted in an electric vehicle. As shown in FIG. 7, the configuration of the heat management system in this embodiment differs from the second embodiment as described below.

Specifically, the heat management system in the present embodiment is constituted of the heat pump circuit 2 and the powertrain cooling circuit 3, and the heater circuit 1 is omitted.

### (Heat Pump Circuit)

The heat pump circuit 2 in the present embodiment differs from the second embodiment in that the first heater 22, the first bypass path 21 and the 3-way valve 23 are omitted.

### (Powertrain Cooling Circuit)

The configuration of the powertrain cooling circuit 3 in the present embodiment is identical to that in the second embodiment.

### (Operations and Effects of Heat Management System)

According to the configuration of the heat management system in the present embodiment described above, unlike the second embodiment, the first heater 22 is omitted from the heat pump circuit 2. Thus, the refrigerant in the heat pump circuit 2 is not actively heated, but the heat pump circuit 2 can operate effectively depending on the temperature of the atmosphere (outside air). In this regard, it is possible to reduce the cost of the heat management system.

According to the configuration in the present embodiment, for the first circulation path 11, the second bypass path 17 is provided detouring around the interior condenser 15 (the first condenser). In the second bypass path 17, the coolant condenser 36 (the second condenser) is placed to release heat into the interior air. The second circulation path 31 through which the coolant circulates is provided for the coolant condenser 36. The battery 34 is placed in the second circulation path 31. Thus, the refrigerant heated while flowing through the first circulation path 11 flows through the coolant condenser 36 via the second bypass path 17. In the coolant condenser 36, the refrigerant in the second bypass path 17 exchanges heat with the coolant in the second circulation path 31, and the thus heated coolant warms up the battery 34. The heat of the refrigerant flowing through the interior condenser 15 is released from the interior condenser 15 into the air in the vehicle interior. That is, the heat released from the interior condenser 15 into the vehicle interior air can heat the vehicle interior. This enables heating of the battery without a heater and achieve cost reduction of the heat management system.

### Sixth Embodiment

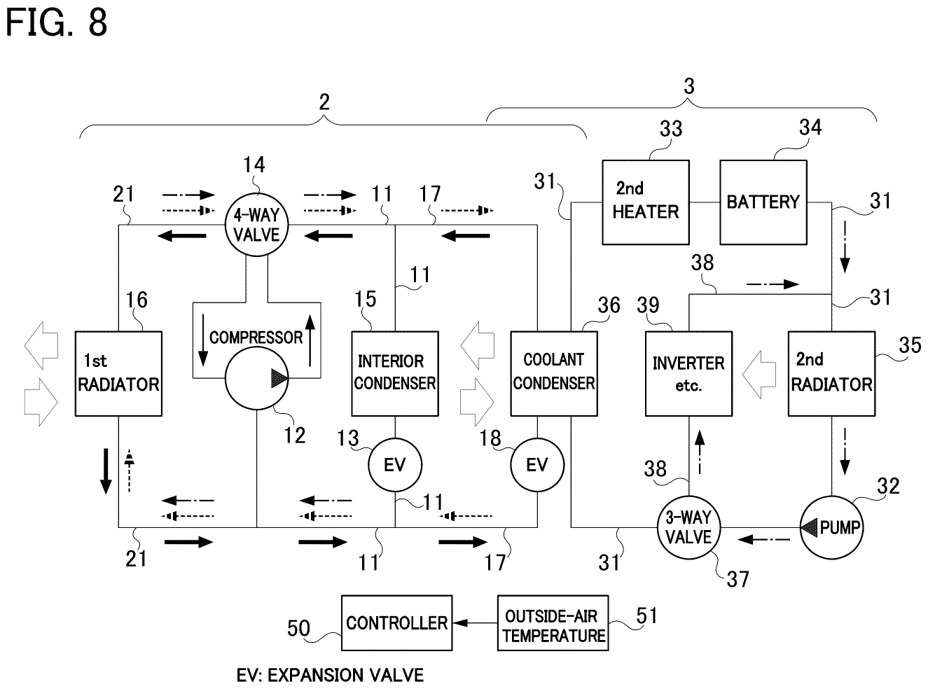

Next, a sixth embodiment will be described in detail with reference to FIG. 8.

### (Configuration of Heat Management System)

FIG. 8 is a block diagram schematically showing a heat management system in this embodiment, which will be mounted in an electric vehicle. As shown in FIG. 8, the heat management system in this embodiment differs from the fifth embodiment in the configuration of the powertrain cooling circuit 3.

### (Powertrain Cooling Circuit)

As shown in FIG. 8, the second heater 33 is placed in the second circulation path 31 between the coolant condenser 36 and the battery 34. This configuration is to actively heat the coolant by the second heater 33 and actively heat the battery 34 with that heated coolant.

### (Operations and Effects of Heat Management System)

According to the configuration of the heat management system in the present embodiment described above, it is possible to effectively warm up the battery 34 with the second heater 33 even at extremely low temperatures as compared with the fifth embodiment.

### Other Embodiments

The disclosure is not limited to each of the foregoing embodiments and may be embodied in other specific forms without departing from the essential characteristics thereof.

In each of the foregoing embodiments, the heat management system is embodied in the cooling and heating apparatus of an electric vehicle. However, as alternatives, the heat management system may be embodied in any other heat pumps, such as an air conditioner for residential use and a heat pump water heater for household use.

### Additional Claims

Each of the embodiments includes similar techniques that can solve the same issues, even though they deviate from the purpose of the disclosure. Those similar techniques are described below as additional claims, together with their operations and effects.

### First Additional Claim

A heat management system provided with a heat pump, the heat pump comprising:
a first circulation path through which a medium circulates;
a compressor provided in the first circulation path to compress the medium;
an expansion valve provided in the first circulation path to expand the medium;
a first condenser placed in the first circulation path between the compressor and the expansion valve to release heat into air in a room interior; and
a first evaporator placed between the compressor and the expansion valve, in a position opposite to a position of the first condenser to absorb heat from atmosphere,
wherein the system comprises:
a first bypass path provided for the first circulation path and extended bypassing the first evaporator;
a third condenser placed in the first bypass path;
a fourth circulation path provided for the third condenser and used for heat exchange with the first circulation path; and
a second heater placed in the fourth circulation path, upstream of the third condenser, and a battery is placed in the fourth circulation path, downstream of the third condenser.

According to the above-described configuration, the heat pump is configured such that the first condenser that releases heat into the room interior air is placed in the first circulation path through which a medium circulates, on one side between the compressor and the expansion valve, and the first evaporator that absorbs heat from the atmosphere is placed between the compressor and the expansion valve, on the opposite side to the position of the first condenser. Here, the heat pump can be activated when a medium is heated to a predetermined temperature (e.g., 0°). In the above configuration, the first bypass path bypassing the first evaporator in the first circulation is provided with the third condenser, and the fourth circulation path for heat exchange with the first bypass path is provided for the third condenser. Further, in the fourth circulation path, the second heater is placed upstream of the third condenser and the battery is placed downstream of the third condenser. Thus, another medium heated by the second heater flows through the fourth circulation path, thereby exchanging heat between the fourth circulation path and the first bypass path in the third condenser. The medium flowing through the first bypass path is then heated and flows to the first condenser via the first circulation path. Further, the heat released from the third condenser is absorbed by the first evaporator and transferred to the medium flowing through the first circulation path, and then released from the first condenser into the room interior air. That is, the heat release from the first condenser into the air can heat the room interior. The battery is warmed up with the other medium heated while flowing through the fourth circulation path. This heat management system does not have a first heater, resulting in a reduced cost just by that much. Further, this system can actively heat the refrigerant flowing through the heat pump by utilizing the second heater used for warming up the battery and others.

### Second Additional Claim

A heat management system provided with a heat pump, the heat pump comprising:
a first circulation path through which a medium circulates;
a compressor provided in the first circulation path to compress the medium; an expansion valve provided in the first circulation path to expand the medium;
a first condenser placed in the first circulation path between the compressor and the expansion valve to release heat into air in a room interior; and
a first evaporator placed between the compressor and the expansion valve, in a position opposite to a position of the first condenser to absorb heat from atmosphere,
wherein the system comprises:
a second bypass path provided for the first circulation path and extended bypassing the first condenser;
a second condenser placed in the second bypass path;
a second circulation path provided for the second condenser, through which another medium circulates; and
a battery placed in the second circulation path, and
wherein the second condenser is configured to exchange heat between the medium in the second bypass path and the other medium in the second circulation path.

According to the configuration of the foregoing technique, the heat pump is configured such that the first condenser that releases heat into the room interior air is placed in the first circulation path through which a medium circulates, on one side between the compressor and the expansion valve, and the first evaporator that absorbs heat from the atmosphere is placed between the compressor and the expansion valve, on the opposite side to the position of the first condenser. Here, the heat pump can be activated when a medium is heated to a predetermined temperature (e.g., 0°). In the above configuration, for the first circulation path, the second bypass path bypassing the first condenser is provided, the second condenser is placed in the second bypass path, and the second circulation path through which another medium circulates is provided for the second condenser, and the battery is placed in the second circulation path. The medium heated while flowing through the first circulation path flows through the second condenser via the second bypass path. In the second condenser, the medium in the second bypass path exchanges heat with another medium in the second circulation path, and the thus heated other medium warms up the battery. The heat of the medium flowing through the first condenser is released from the first condenser into the room interior air. That is, the heat release from the first condenser to the room interior air can heat the room interior. This enables heating of the battery without a heater and achieve cost reduction of the heat management system.

### INDUSTRIAL APPLICABILITY

The disclosure can be utilized in a heat pump which will be used to cool and heat an electric vehicle.

### REFERENCE SIGNS LIST

11 First circulation path
12 Compressor
13 Expansion valve
14 4-way valve (Second switching valve)
15 Interior condenser (First condenser)
16 First radiator (First evaporator)
17 Second bypass path
21 First bypass path
22 First heater
23 3-way valve (First switching valve)
31 Second circulation path
33 Second heater
34 Battery
36 Coolant condenser (Second condenser)
41 Fourth circulation path
46 Coolant condenser (Third condenser)
50 Controller (Control unit)

1. A heat management system provided with a heat pump, the heat pump comprising:
a first circulation path through which a medium circulates;
a compressor provided in the first circulation path to compress the medium;
an expansion valve provided in the first circulation path to expand the medium;
a first condenser placed in the first circulation path between the compressor and the expansion valve to release heat into air in a room interior; and
a first evaporator placed between the compressor and the expansion valve, in a position opposite to a position of the first condenser to absorb heat from atmosphere,
wherein the system comprises:
a first bypass path provided for the first circulation path and extended bypassing the first evaporator; and
a first heater placed in the first bypass path to heat the medium that flows through the first bypass path.

2. The heat management system described in claim 1, comprising:
a second bypass path provided for the first circulation path and extended bypassing the first condenser;
a second condenser placed in the second bypass path;
a second circulation path through which another medium circulates, provided in the second condenser; and
a battery that is placed in the second circulation path and heated by the other medium,
the second condenser being configured to exchange heat between the medium in the second bypass path and the other medium in the second circulation path.

3. The heat management system described in claim 1, comprising a first switching valve for switching a flow of the medium between the first circulation path and the first bypass path.

4. The heat management system described in claim 1, comprising a second switching valve for switching a flowing direction of the medium in the compressor.

5. The heat management system described in claim 3, further comprising a control unit for controlling the first switching valve and the first heater,
wherein when the medium is below a predetermined temperature, the control unit controls the first switching valve to switch the flow of the medium in the first circulation path to the first bypass path and controls the first heater to be operated.

6. The heat management system described in claim 5, wherein the control unit controls the first switching valve to gradually change the flow of the medium between the first circulation path and the first bypass path.

7. The heat management system described in claim 2, comprising a first switching valve for switching a flow of the medium between the first circulation path and the first bypass path.

8. The heat management system described in claim 2, comprising a second switching valve for switching a flowing direction of the medium in the compressor.

9. The heat management system described in claim 7, further comprising a control unit for controlling the first switching valve and the first heater,
wherein when the medium is below a predetermined temperature, the control unit controls the first switching valve to switch the flow of the medium in the first circulation path to the first bypass path and controls the first heater to be operated.

10. The heat management system described in claim 9, wherein the control unit controls the first switching valve to gradually change the flow of the medium between the first circulation path and the first bypass path.
